(19) United States
(12) Patent Application Publication
(10) Pub. No.: US 2003/0154125 A1
(43) Pub. Date: Aug. 14, 2003

(54) Pesonalisation of promotional offers

(75) Inventors: Parul A. Mittal, New Delhi (IN); Vivek Jain, New Delhi (IN)

Correspondence Address: INTERNATIONAL BUSINESS MACHINES CORPORATION, ALMADEN RESEARCH CENTER, 650 HARRY ROAD, SAN JOSE,, CA, 95120, US

(73) Assignee: International Business Machines Corporation, Armonk, NY

(21) Appl. No.: 09/863,921

(22) Filed: May 23, 2001

(51) Int. Cl. G06F 17/60

(52) U.S. Cl. 705/14

(57) ABSTRACT

A promotional scheme involving the design, distribution and redemption of electronic coupons involves defining the structure of a promotional offer to be made to customers, in which the offer has associated parameters, one or more of which are unspecified or variable. The offer is targeted to customers, and one or more of the unspecified or variable offer parameters associated are finalised, either before or after distribution.

### FIELD OF THE INVENTION

The invention relates to the personalisation of promotional offers and relates particularly, though not exclusively to the dynamic personalisation and online distribution of electronic coupons for discounts on products and services.

### BACKGROUND OF THE INVENTION

The use of promotional offers has been widely studied. Store coupons are issued by merchants to attract shoppers in the merchant's local area. Coupons are typically issued for national brands that enjoy a wide distribution.

The distribution and redemption of promotional coupons on the Internet during online shopping has been proposed. The emphasis in existing coupon schemes involves the use of appropriate security measures to prevent alteration, duplication, and trading of coupons amongst customers, and fraudulent use of a manufacturer's coupons by retailers.

While various methods of implementing online coupon schemes have been put forth, these methods largely address weaknesses inherently associated with the electronic distribution in which there is no physical coupon, rather than the limitations associated with promotional discount schemes per se.

In this way, efforts to date have attempted to provided an electronic coupon analogous with the paper-based equivalent, rather than seeking to inherently modify the structure or operation of the coupon scheme per se.

It is accordingly an object of the invention to at least attempt to address these and other limitations associated with existing proposals.

### SUMMARY OF THE INVENTION

The inventive concept involves a recognition that promotional schemes can be advantageously improved through the use of promotional offers having unspecified or variable parameters that are able to be personalised to individual customers as required.

Embodiments of the invention attempt to provide an improved promotional offer scheme in which offer parameters are personalised for individual customers in order to maximise operator revenue. Accordingly, offer parameters are preferably personalised to, in general, offer a sufficient but not overwhelming enticement to take advantage of the respective offer.

Embodiments of the invention disassociate the selection or finalisation of offer parameters from the process of actually creating or distributing a record of the offer (that is, the conventional coupon). This disassociation can have various advantages by introducing greater flexibility in adjusting the conduct of the promotional offer scheme in which the offer is current. Further, various related parties can have constructive input into the selection of offer parameters, typically based on information known about customers. Selection of one or more particular offer parameters (such as, for example, offer discount amount) can be postponed until necessary. This allows further information concerning customer behaviour and customer response to the promotional offer to be obtained before finalising offer parameters for individual customers.

Some of the coupon promotion parameters are preferably decided at the time of coupon creation. The decision of assigning offer parameters may be performed by entities other than the entity involved in creation of the offer coupons, as such entities may be in a position to determine appropriate offer parameters based a more detailed or relevant user profile.

The invention provides a method of conducting a promotional offer, the method including:

defining the structure of a promotional offer to be made to a plurality of customers, the offer having a plurality of associated parameters, one or more of which are unspecified or can be varied; and

targeting one or more of a plurality of customers as recipients of the offer, and defining one or more of the unspecified parameters associated with the offer, for each of the targeted customers to whom the record of the offer is distributed.

The step of defining one or more of the unspecified parameters of the offer can occur:

(a) at the time of distribution of the offer to the respective customers; and/or

(b) at the time of redemption of the offer by the respective customers.

There are various entities which may be engaged in the promotional offer:

(a) a promoting entity, who typically conceives and/or designs a coupon-based promotional scheme for sale of its goods or services, or the goods or services of those by whom it is engaged to promote those goods or services.

(b) a distribution entity, who distributes a record of the offer to a plurality of redeeming entities, or prospective/actual customers.

(c) a retailing entity, who is the entity before which the offers are actually redeemed.

In preferred embodiments, the record of the promotional offer is an electronic coupon, which is distributed and redeemed online with the involvement of distribution and retailing entities which have an online presence. The retailing entity is an electronic store.

### BRIEF DESCRIPTION OF THE DRAWINGS

FIG. 1 is a flowchart of the various steps which occur in providing promotional offer coupons in accordance with an embodiment of the invention.

FIG. 2 is a schematic representation of the relationship between various entities involved in the method of FIG. 1.

FIG. 3 is a flowchart representing a different set of steps which occur in providing promotional offer coupons in accordance with an embodiment of the invention.

FIG. 4 is a flowchart representing a further set of steps which occur in providing promotional offer coupons in accordance with an embodiment of the invention.

FIG. 5 is a flowchart representing the steps involved in the conduct of the promotional offer, from the perspective of the coupon originator.

FIG. 6 is a representation of the steps involved in determining coupon parameters.

FIG. 7 is a representation of the steps involved in determining product utility and hence coupon value.

FIG. 8 is a representation of the steps involved in determining a customer's utility function.

FIG. 9 is a representation of the steps involved in using price difference to determine coupon value.

FIG. 10 is a representation of the steps involved in using price difference and utilities to determine coupon value.

FIG. 11 is a representation of the steps involved in using customer inter-purchase time information to determine coupon validity period.

FIG. 12 is a representation of the steps which occur when a coupon is redeemed.

FIG. 13 is a schematic representation of computing equipment able to be used in performing embodiments of the invention.

### DETAILED DESCRIPTION OF EMBODIMENTS AND BEST MODE

An embodiment of the invention is described below in the context of the electronic creation, distribution and redemption of promotional offers involving “electronic coupons”.

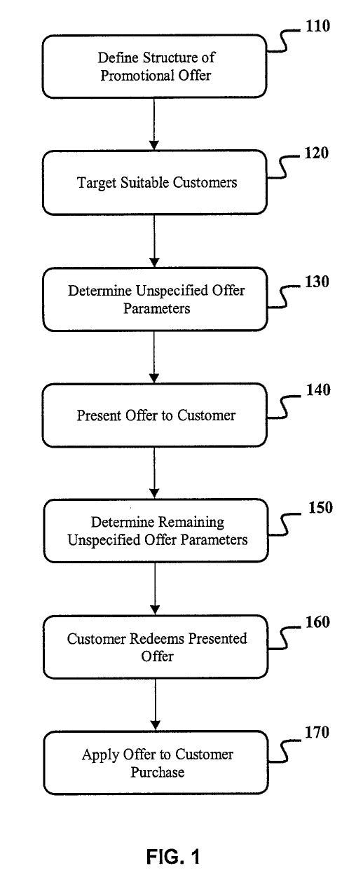

With reference to FIG. 1, the major steps in this process are now described. The structure of a promotional offer is defined in step 110, in which the offer has various parameters, some or all of which may be varied as required between different values to suit different prospective customers. The promotional offer is targeted in step 120 to a number of customers, and a record of the offer distributed to them in step 140.

The unspecified or variable parameters of the offer are finalised in steps 130, 150 for each targeted customer to whom the record of the offer is distributed, either at the time of distribution (step 130), or time of redemption (step 150), or a combination of both. Assigning unspecified or variable parameters is typically done with direct reference to customer profile information associated with respective targeted customers, in order to maximise the take up rate of the offer, or the revenue generated as a result of the promotional offer. When the customer redeems the offer, in step 160, the appropriate discount is applied, in step 170.

One or more parameters associated with promotional offers made to individual customers can be specified after creation of the promotional offer, so that the precise nature of the promotional offer can be adjusted (that is, more particularly specified) closer to the time when the offer is redeemed.

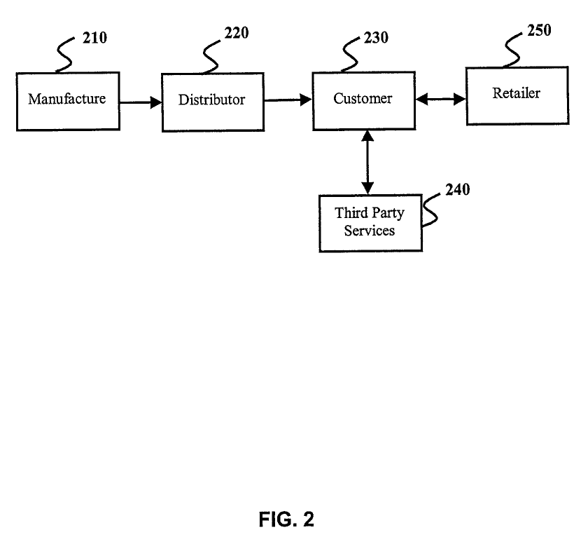

In view of the above, there are typically various entities which interact in the course of dealing with a coupon offer. In FIG. 2, the relationship between these parties is depicted. A manufacturer 210 or promoting entity typically initiates the promotional offer to promote one of its products. The promoting entity typically conceives and/or designs the coupon-based promotional scheme for sale of its goods or services, or the goods or services of those by whom it is engaged to promote those goods or services.

A distributor 220 or distribution entity or partner, distributes a coupon, or record of the offer, to a plurality of redeeming entities, or prospective/actual customers 230. Coupons may typically be distributed on behalf of a manufacturer as part of a promotional campaign for the manufacturer's products.

Customers receive electronic coupons from distribution partners, and may take responsibility for storing those coupons themselves or, otherwise, storing the coupons with the assistance of a third party provider 240. Customers seek to redeem electronic coupons before a retailer 250 or retailing entity who stocks the manufacturer's products.

Defining the Structure of the Promotional Offer

The structure of a promotional offer is defined typically by the manufacturer of the relevant product or service, or an agent involved in sales promotion on behalf of the manufacturer.

The manufacturer may create a number of promotions with possibly different objectives. The manufacturer, in devising the structure of the promotional offer, leaves some of the coupon parameters unspecified or able to be varied, for example, the discount amount, the coupon validity period etc. The manufacturer may also provide additional details, such as the number of coupons to distribute, the promotion budget, customer profiles (collaborative as well as individual) etc. for subsequent use in targeting the respective promotional offers.

A structural definition of the promotional offer is stored in a database or other similar file system. This definition includes various parameters, such as those below, some of which may be determined later by other entities involved in the promotional offer.

Description of the discounted product or service. In case of a product, a universal product code (UPC) may be used to identify the product. A similar appropriate identification may be used in case of a discounted service. The information may alternatively identify a group of products and/or services, e.g., discounts on all products/services of a specified brand. There may be more than one product information on the coupon, i.e., the discount is applicable only if the customer purchases all the products specified. For instance, promotions, e.g., buy a computer and get 50% discount on table, or buy one and get another free.

Amount of discount offered. This information may either be written explicitly in terms of a percentage discount or the actual amount of discount, or it is described in the form of a mathematical or logical expression, which is later evaluated to determine the actual amount of the discount.

Offer validity period. For example, a pizza shop or cinema may give discount coupons that are only applicable on Tuesdays only. Similarly there may be weather-related coupons or seasonal coupons, e.g., coupons that are valid in the post-Christmas season or in the season between Halloween and Thanksgiving, etc. The offer validity period can be absolute or relative to the time of offer issuance, the time of coupon parameter determination etc.

Life of coupon promotion. This defines the length of promotion, and is distinct from the validity period of the coupon. The validity period of the offer is a subset of the life of coupon promotion. The life of coupon promotion is preferably determined at the time of promotion offer creation, in contrast with the validity which, desirably, is determined at a later time.

Other terms and conditions of the offer. Some offers may be applicable only if the customer buys all of a certain set of products or services, some offers may require purchase of just one product or service, and yet other offers may require purchase of k out of n specified products or services. Similarly some offers may require the customer to spend a minimum specified amount of money on specified products. Alternatively there may be offers requiring the customer to collect a set of coupons satisfying a specified condition. The offer is applicable only if the customer presents a set of coupons satisfying the specified condition. Some representative examples are:

(i) Loyalty points: each coupon contains some loyalty points. The offer is given when a customer presents coupons totalling a specified number.

(ii) Each coupon contains a letter of English alphabet. The offer is given when a customer presents coupons making a specified word.

An endless variety of terms and conditions are possible.

Promotional description of the offer. This may be in form of text, images, audio, video, or any multimedia electronic document format.

Personalization information. Possibly consisting of the information describing the intended recipient of the product or the service. In case the coupon is targeted to a specific customer, then his/her name, credit card number, driver's license number, social security number or any other form of identification may be used for identification purposes. Sometimes it is not desirable to put this information explicitly on the coupon. In this case a hash function may be used. A hash function maps a sequence of bytes to another sequence of bytes, wherein the second sequence is usually smaller (in length) than the first one of this information may be put on the coupon. A plurality of the above conditions may be used for customer identification. In case the promotion is targeted to a class of users, other identification parameters like the city of residence, his/her Internet service provider, or the brand of computer/software owned by him/her may be used. A coupon containing a personalization information is valid for use only by the customer or class of customers described.

Targeting Customers

The targeting and distribution of promotional offers is typically performed by a distribution agency which acts on behalf of a number of manufacturers, or by the individual manufacturers themselves.

A party independent of any particular manufacturer may distribute electronic coupons for a plurality of manufacturers to the customers in a targeted manner.

Targeting is preferably performed on the basis of the defined structure of the promotional offer, and the objective of the promotional offer (for example, move a particular line of old stock, create awareness for a new brand, etc). The targeting process may also be influenced by the number of coupons to be distributed, the allocated promotion budget, the available customer profiles (collaborative as well as individual) for targeting coupons for each promotion.

For targeted customers so identified, at least some of the unspecified or variable parameters of the promotional offer may be assigned for each these targeted customers.

As a result, the value of some of the unspecified coupon parameters may be assigned, and a personalised coupon offer offered to each targeted customer, typically through a Web site, e-mail or other electronic media.

Redemption of Offers

Customers accept the electronic coupon offered to them through any one of a number of electronic media. A customer may have the option of saving the coupon on a local desktop or with, for example, a third party coupon storage service provider, or a Web site associated with a particular retailer.

An online retailer typically takes responsibility for offer redemption. The retailer receives the set of electronic coupons that the customer wishes to redeem for a specific purchase. The authenticity and integrity of the coupon is verified, and the applicability of the coupon to the claimed purchase is checked, as well as any invalidating earlier usage of the coupon.

The retailer also checks for any remaining unspecified or variable promotional offer parameters and determines their value. The customized coupon promotion is thus finalised and presented to the customer, together with the relevant discount applicable to the customer's intended purchase.

A customer may visit an online site, such as a Web site, owned or operated by the manufacturer or the manufacturer's distribution partner or their agent. The online site has access to a customer profile information database for a number of customers. Suitable customer profile information may be determined from click-stream, purchase history, demographics etc. The site uses the customer profile information to target suitable customers as recipients of the promotional offer, in accordance with predetermined criteria based on the objectives of the promotional offer.

Depending on customer profile and various promotion policies, the coupon promotion to be offered to the customer is determined. The value of some of the unspecified parameters for a chosen coupon promotion may be determined, and a customized coupon promotion created and offered to the customer.

The customer visits an on-line retailer, at a later point in time, makes some online purchase and chooses to redeem a set of his/her electronic coupons. The retailer verifies the authenticity and integrity of the coupon, determines the applicability to the purchase and checks for earlier usage of the coupons. It then gives the relevant discount to the customer for the redeemed coupons.

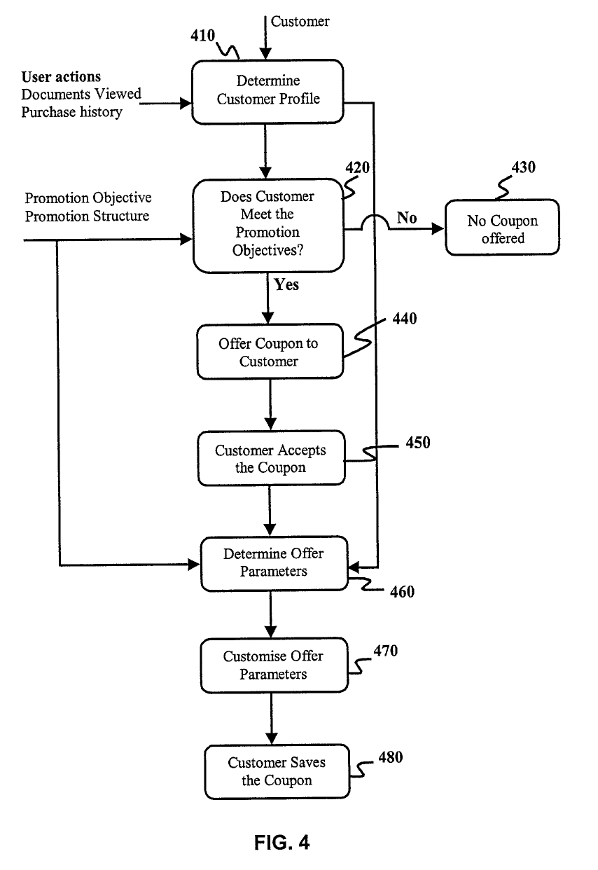

FIG. 4 is a modified flowchart depicting the sequence of events. The additional information that the user has accepted the coupon reflecting his interest in the product can enable the distribution entity to further improve the determination of the coupon parameters.

Coupon Parameters Determined at Coupon Redemption

Coupon parameters may be determined by the redeeming retailer. However, the time period between offering the coupon and the customer presenting the coupon at an online store for redemption enables the retailer to learn more about the customer and provide more appropriately personalized coupons in future, either in terms of the structure of the promotional offer, or the parameters of the offer.

The distribution partner offers a coupon to the customer and decides to postpone selection of all or some of the coupon promotion parameters. When the customer presents the coupon for redemption at a retailer store, it is checked whether there are any unspecified promotion parameters of the coupon. If this is the case, the value of any unspecified parameters is determined, and a customized coupon promotion created and presented to the customer.

The manufacturer also provides information regarding promotion objectives, promotion budget, customer profiles etc. The customer makes some online purchase and chooses to redeem a set of his/her electronic coupons. The retailer verifies the authenticity and integrity of the coupon, determines the applicability to the purchase and checks for earlier usage of the coupons. It then gives the relevant discount to the customer for the redeemed coupons.

In another embodiment, the customer may present the coupon for redemption at a retailer store, become aware of the unknown coupon parameters, may decide not to redeem the coupon and store it for future use. Alternatively, a specific online site or its agent or a physical entity with authority to specify coupon parameters online may be designated where a customer can present the coupon for determining the value of coupon parameters.

In this embodiment, the distribution partner offers a coupon to the customer and decides to postpone selection of all or some of the coupon promotion parameters. The decision regarding the unspecified coupon promotion parameters is made when the customer presents the coupon. The manufacturer also provides the information regarding promotion objectives, promotion budget, customer profiles etc., which is used to decide the value of the unspecified parameters for a chosen coupon promotion, creates a customized coupon promotion and offers it to the customer. The customer accepts the coupon and stores it in his/her local desktop, or with a third party coupon storage service provider.

The customer visits an online retailer, at a later point in time, makes some online purchase and chooses to redeem a set of his/her electronic coupons. The retailer verifies the authenticity and integrity of the coupon, and determines the applicability to the purchase and checks for earlier usage of the coupons. It then gives the relevant discount to the customer for the redeemed coupons.

Store Coupons

A single entity can conduct all steps in the promotional offer scheme, in which case the promotion corresponds to a conventional “in-store” coupon scheme. A coupon is offered to the customer based on the targeted profile, without deciding or disclosing the coupon parameters. This allows the store to learn more about the customer from their activities on the store site or through other secondary information. This information can be used to update their customer profile information.

The customer stores the coupon in his wallet, and selects the coupon and presents it to the store for redemption or determination of coupon parameters. When this occurs, the store determines the coupon parameters depending on the updated profile of the customer. This is distinct from random value coupons or time-decay coupons as the value is based on the updated profile of the customer and not on time or a random function. The updated coupon is offered to the customer which can be stored. The customer can decide not to redeem the coupon after being informed the value of the coupon. The coupon can be redeemed later, in which case the coupon parameters remain fixed. In either case, the customer sends the updated coupon to the store for redemption. The store verifies the coupon and receives the verified coupon. The coupon is then redeemed, and the appropriate discount is offered to the customer.

Alternatively, once the coupon parameters have been specified and disclosed to the customer, the coupon value is set to decline with time. The rate of decline in the incentive value with time could be a linear, polynomial or exponential function. In this instance, as the customer is aware of the decay in coupon value once the coupon parameters have been specified, a rational customer would only specify the coupon parameters close to the intended time of redemption. Instant redemption coupons are a specific instance of infinite decay in coupon value.

In some embodiments, the manufacturer may specify the value for some coupon parameters, while remaining parameters are specified when individual customers are targeted or when the coupon is sought to be redeemed.

The manufacturer may specify default values for some of the parameters. The default values are hidden from the customer until an entity specifies those default values to be the final coupon parameter values.

For any unspecified or variable offer parameters, the manufacturer or another party may specify default parameter values, or rules which govern how offer parameters are defined for respective customers. The default values can be changed only once or a predetermined number of times before the offer is presented to the customer.

The manufacturer may specify the average value, lower and upper bounds on value of the unspecified coupon parameters. For instance, the manufacturer may specify an upper bound on the value of the coupon to prevent steep discount offers causing damage to the manufacturer. The manufacturer may specify actual a finite discrete number of values that offer parameters may take.

The manufacturer or other entity responsible for the promotional offer may implement an associated incentive scheme for those actually targeting customers and/or determining the coupon offer parameters. Rewards or incentives would typically be based on some measure of the success of the promotional offer amongst customers. Entities involved in contributing to targeting of customers or determining coupon parameters may be required to endorse coupons with which they are associated so that the manufacturer is aware of the activities of these entities, and the extent of their contribution to the final coupon offered and redeemed by customers.

The generation, distribution, storage, redemption, validation and clearing of electronic manufacturer coupons and electronic store coupons may involve a centralized coupon mint which generates unique blank digital coupons. The promoter of the offer then writes the terms and conditions and other details of the offer on blank coupons. These customized coupons are digitally signed by the promoter and distributed to potential customers. A customer may either present these coupons electronically for redemption to an online store, or print these coupons and present them to a conventional off-line store. The store may check the authenticity of a coupon by verifying the digital signature and also verifying if the coupon has not been used earlier by contacting a verification center.

The store collects all redeemed coupons and sends these to a manufacturer for clearing. The distributor or the redeeming retailer can determine some of the coupon parameters, after the coupon creation by the promoter, in a dynamic, on-line and targeted manner.

A number of methodologies exist to generate customer profiles. Preferably, in the described embodiments, a linear regression method is used to implement a random coefficient choice model, in accordance with the approach described by Peter E. Rossi, Robert E. McCulloch, Greg M. Allenby, The Value of Purchase History Data in Target Marketing, Marketing Science, Vol. 15, No. 4, 1996, the contents of which are hereby incorporated by reference. Heterogeneity among customer groups is related to observable demographics, which can be extended to include other elements of customer profile. The historic response to coupon offers is correlated with product utility, enabling a decision regarding whether the coupon shall be offered or not. Coupons are customized to specific households on the basis of various information sets.

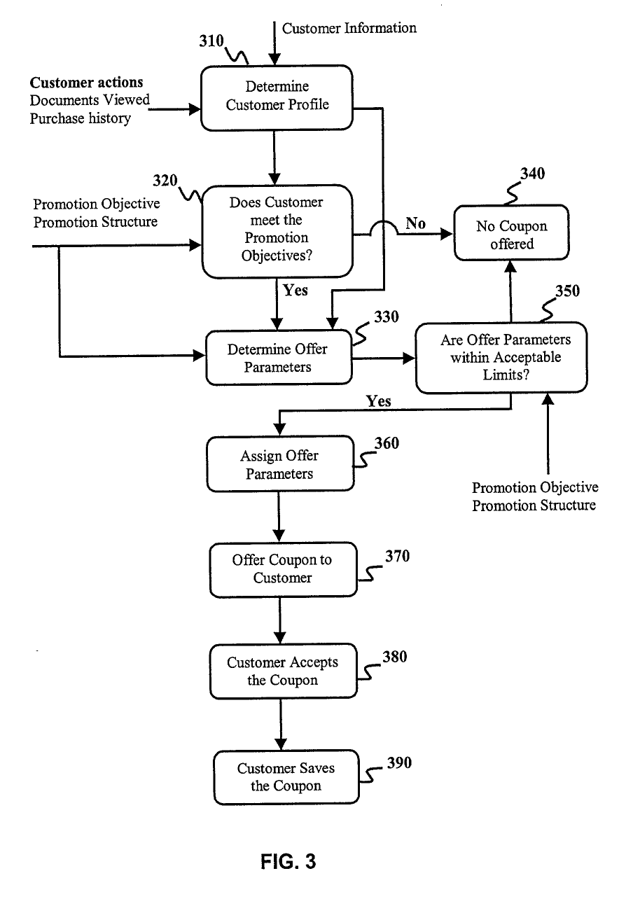

FIGS. 3 and 4 illustrate alternate methods by which coupon parameters are supplied. In FIG. 3, a customer profile is determined in step 310, based on customer actions and customer information. In step 320, it is determined whether that given customer is appropriate for participation in the promotional offer. If not, no coupon is offered (step 340). If the customer meets the promotional objectives, appropriate coupon parameters are determined, in step 330. If these determined coupon parameters are within acceptable limits, as decided in step 350, then these parameters are assigned in step 360, and the offer presented to the customer, in step 370. The customer may then accept the offer (step 380) and store it for later redemption (step 390).

In FIG. 4, similar steps occur, except the offer is immediately presented to the customer, in step 440, once it is determined in step 420 that the customer meet the promotional requirements. Only once the customer accepts the coupon, in step 450, are the coupon parameters determined, in step 460.

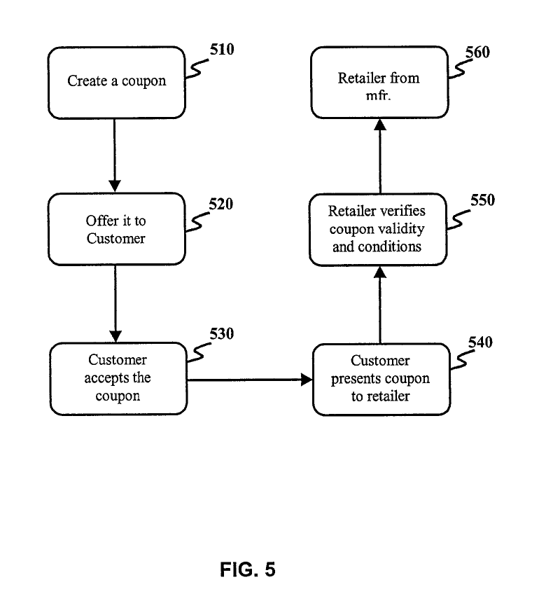

With reference to FIG. 5, the coupon goes through different basic stages of transformation from its creation to redemption. Usually, the promotion specific coupon parameters are decided at the time of creation of the coupon. The value of coupon parameters can be decided at any stage of the coupon life cycle, rather than just at the stage of creation. Initially, the coupon is created in step 510, and offered to the customer (step 520) who accepts the coupon (step 530). The customer presents the coupon (step 540) to a redeeming retailer, who verifies the coupon's validity (step 550). Once redeemed, the retailer may claim back an appropriate discount from the manufacturer, in step 560.

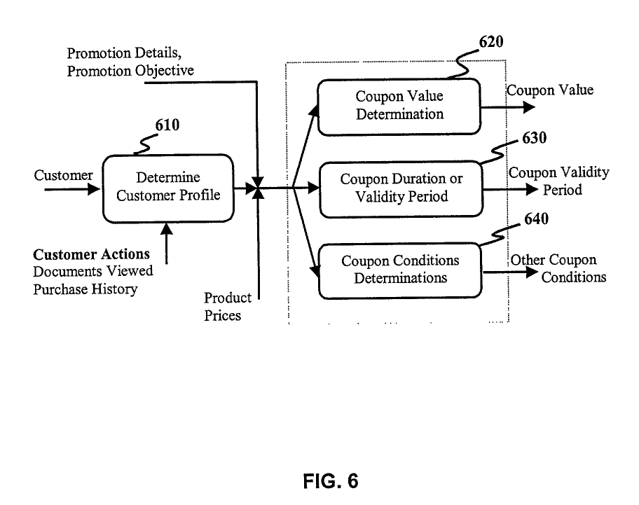

Coupon parameter determined can occur during targeting and/or redemption. Coupon parameter determination uses different personalization techniques to determine the coupon parameters to meet the desired objectives of the manufacturer, for example, increasing the redemption rate and, at the same time, keeping the cost of the coupon low. Coupon parameter determination can be conceived as consisting of three key components, as represented in FIG. 6. Once the customer profile is established in step 610, the coupon value, validity period and coupon conditions are determined in steps 620, 630 and 640 respectively.

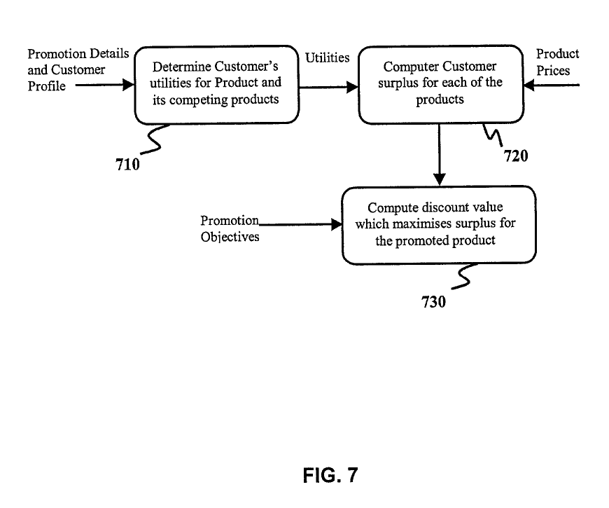

In one instance, an online entity can determine, for each consumer, the utilities of each brand in a competitive class. This process is represented in FIG. 7. Once having determined the utility of competing products in step 710, the distribution partner can offer a discount calculated in step 730 such that the calculated consumer surplus (that is, the difference between the utility and the price determined in step 720) for the promoted brand exceeds the preferred brand. A rational consumer purchases a product if the utility from its purchase and consumption exceeds the price at which the product is bought, namely the consumer surplus.

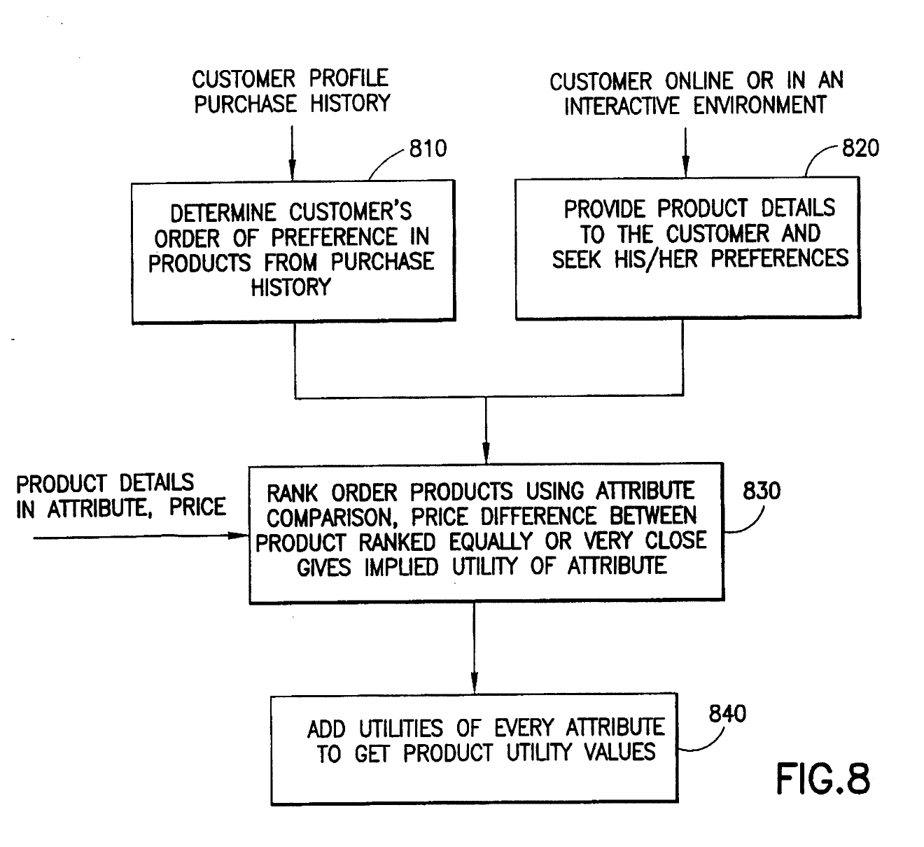

A customer's purchase decisions therefore contains information about his/her utility function, which can be used in the manner represented in FIG. 8. A ranked list of preferred products is determined in step 810, or the customer is engaged to determine this information in step 820, or both. A decision to purchase or not to purchase at different prices allows computation of that individual customer's utility for the product. The existing practice of conjoint analysis can be used in step 830 to not only determining the utility for each product but also the utility of each of the product attributes. Utility functions thus determined in step 840 can be used to determine the value of the coupon to be offered such that the consumer maximizes his/her surplus for the product being promoted.

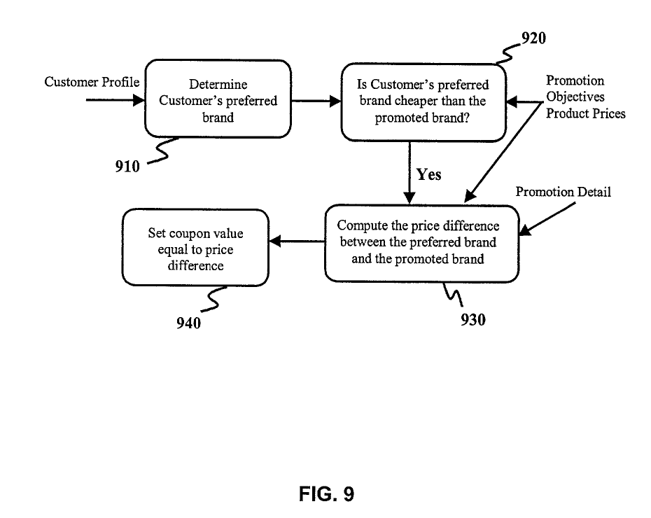

In another instance, coupons of value may be offered which are equivalent to the price differential between the preferred brand of the customer and the promoted brand, as illustrated in FIG. 9. Compared to the previous case, the implicit assumption here is that the utility of consumption of the competing brands is the same. The value determination can be achieved first determining the most preferred brand of the current user in step 910. The user profile contains the purchase history details of the user. The last brand purchased or the brand with the highest frequency of purchase or brand with the highest exponential weighted average of purchases is taken as the most preferred brand. It is then determined whether the customer's preferred brand is cheaper than the promoted brand, in step 920. If so, the price difference is calculated (step 930), and the coupon value set to this price difference (step 940).

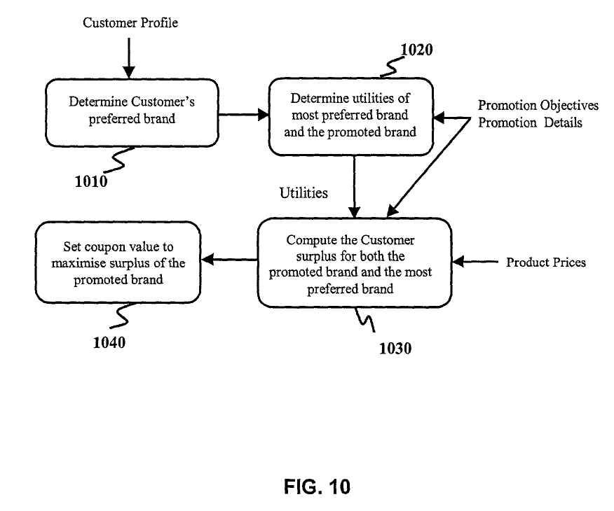

A combination of the above two approaches may be used, as illustrated in FIG. 10. First, the preferred brand is determined (step 1010, and then the customer's utilities for the preferred brand and the promoted brand are determined (step 1020). The customer surplus is calculated (step 1030) for both the promoted and preferred brands, and the coupon value assigned to maximize that customer's surplus with respect to the promoted brand.

The coupon validity period is determined as a function of a customer's purchase history, his coupon usage history and promotion objectives. As a general proposition, stronger brands can be promoted with shorter duration coupons and weaker brands promoted with longer duration coupons. The frequency of coupon offers determines a practical upper range on the validity period. Manufacturers prefer to restrict validity to within a time period when they are planning to offer new coupons again.

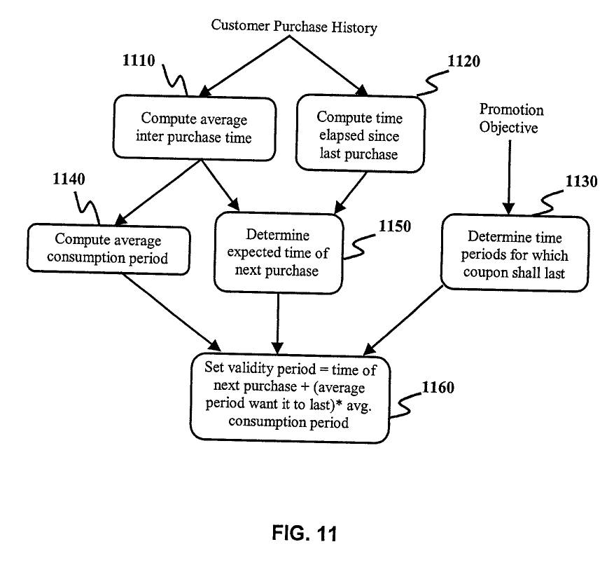

The inventory of product at the customer's end which is a function of time elapsed since last purchase and his/her consumption rate (reflected in average inter-purchase time) determines expected time of his next purchase. The validity period shall at least cover the expected timing of next purchase. There are several heuristic techniques which can be proposed based on frequency of coupon offerings and validity period of coupon, as illustrated in FIG. 11.

Customer information is used to calculate both the average inter-purchase time and the time since the last purchase, in steps 1110 and 1120. This information is used to predict the time of the next purchase as well as the average consumption period, in steps 1140 and 1150. Using this information, and the coupon duration determined in step 1130 the validity period is determined in step 1160.

High frequency coupon offerings may even prefer instant redemption coupons. A learning and feedback process (for example, using neural networks) would improve the performance of validity period selection.

Coupon Condition Determination

The manufacturer may specify additional conditions which may have to be checked at each stage of the offer processing for compliance or validity. These conditions may be on the profile of the consumer, for example, restricting the use of coupon to customers loyal to a particular redemption store. The loyal customer definition may be left open for interpretation by the redemption store or specified by the distribution partner or retailer. Such a requirement could be translated into a condition that, for example:

The customer has made past purchases of at least $1,000 at the redeeming store.

The customer has made at least 5 purchases at the redeeming store.

The customer has bought another product at least once on a previous occasion at the redeeming store.

Another example of coupon conditions is a co-purchase condition. This involves a condition, for example, that the coupon is valid only if another product or category is simultaneously purchased along with the specified product to which the coupon relates.

The selection of the above conditions is based on heuristics and customer profile information held by any relevant entity. If one entity concludes from previous experience that one set of conditions works better than the other, it may decide to use those conditions. The coupon condition determinant essentially uses the information with the entity to customize the coupon value. It utilizes the information asymmetry between the manufacturer and the online entities.

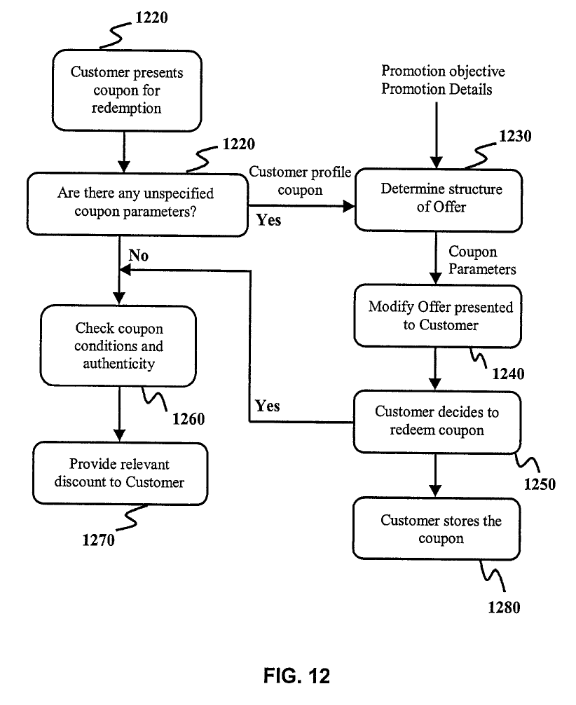

The redeeming store checks if a coupon presented by the user for redemption has unspecified parameters and, if required, determines these parameters This process is illustrated in FIG. 12. A customer presents a coupon for redemption in step 1210, and it is determined whether there are any remaining parameters to be assigned in step 1220. If there are, these parameters are determined and assigned in the usual way in steps 1240 and 1250. In either case, if the customer decides to redeem the coupon (step 1250), the coupon is checked and verified in step 1260 and the relevant discount applied (step 1270).

Other Embodiments

Various additions and modifications to the embodiment described above are possible. A retailing site may distribute promotional offers to customers on predetermined triggering events (for example, when a customer purchasing a specific product, time of the day, time of the year, or inventory held by the retailer).

A number of different promotional offers can be returned to the requesting site, which decides among these different promotional offers to select one or more to present to the customer.

A promotional offer may be distributed exclusively via e-mail, or via some other direct access medium, for example, postal mail, mobile or telephone call. In this case, the customer can collect the coupon via e-mail or by visiting an online site or sites.

Coupon parameters may be determined after the customer accepts the coupon. The coupon is offered by a distribution partner to the customer and the allocation of the coupon parameter values is postponed. Once the customer accepts the coupon, for example, by clicking on the coupon or saving the coupon, the coupon parameters are determined and, for example, a discount or previously unknown value presented to the customer.

Implementation in Computer Hardware and Software

Suitable equipment for conducting the promotional offer can be a web based application or a stand alone software with an user interface which can be accessed over a network using a browser or pervasive devices.

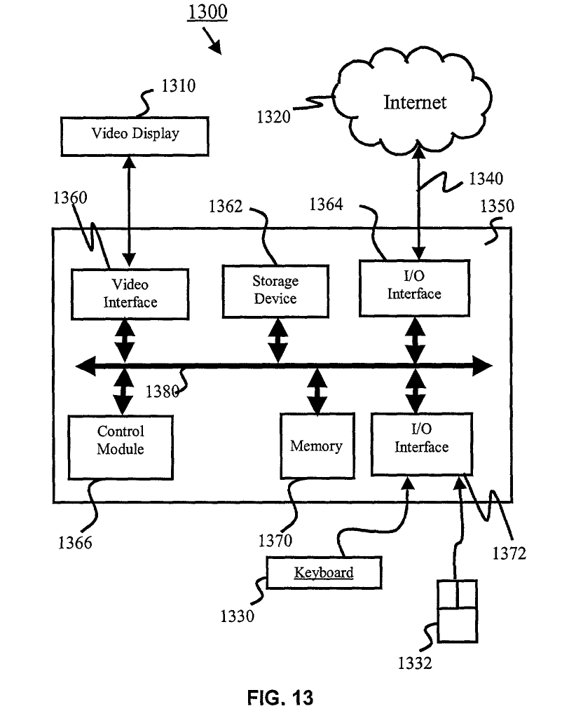

More particularly, the described process of conducting a promotional offer can be implemented using a computer program product in conjunction with a computer system 1300 as shown in FIG. 13. In particular, the process can be implemented as software, or computer readable program code, executing on the computer system 1300.

The computer system 1300 includes a computer 1350, a video display 1010, and input devices 1330, 1332. In addition, the computer system 1300 can have any of a number of other output devices including line printers, laser printers, plotters, and other reproduction devices connected to the computer 1350. The computer system 1300 can be connected to one or more other computers via a communication input/output (I/O) interface 1364 using an appropriate communication channel 1340 such as a modem communications path, an electronic network, or the like. The network may include a local area network (LAN), a wide area network (WAN), an Intranet, and/or the Internet 1320.

The computer 1350 includes the control module 1366, a memory 1070 that may include random access memory (RAM) and read-only memory (ROM), input/output (I/O) interfaces 1364, 1372, a video interface 1360, and one or more storage devices generally represented by the storage device 1362. The control module 1366 is implemented using a central processing unit (CPU) that executes or runs a computer readable program code that performs a particular function or related set of functions.

The video interface 1360 is connected to the video display 1310 and provides video signals from the computer 1350 for display on the video display 1310. User input to operate the computer 1350 can be provided by one or more of the input devices 1330, 1332 via the I/O interface 1372. For example, a user of the computer 1350 can use a keyboard as I/O interface 1330 and/or a pointing device such as a mouse as I/O interface 1332. The keyboard and the mouse provide input to the computer 1350. The storage device 1362 can consist of one or more of the following: a floppy disk, a hard disk drive, a magneto-optical disk drive, CD-ROM, magnetic tape or any other of a number of non-volatile storage devices well known to those skilled in the art. Each of the elements in the computer system 1350 is typically connected to other devices via a bus 1380 that in turn can consist of data, address, and control buses.

The method steps for are effected by instructions in the software that are carried out by the computer system 1300. Again, the software may be implemented as one or more modules for implementing the method steps.

In particular, the software may be stored in a computer readable medium, including the storage device 1362 or that is downloaded from a remote location via the interface 1364 and communications channel 1340 from the Internet 1320 or another network location or site. The computer system 1300 includes the computer readable medium having such software or program code recorded such that instructions of the software or the program code can be carried out. The use of the computer system 1300 preferably effects advantageous apparatuses for constructing a runtime symbol table for a computer program in accordance with the embodiments of the invention.

The computer system 1300 is provided for illustrative purposes and other configurations can be employed without departing from the scope and spirit of the invention. The foregoing is merely an example of the types of computers or computer systems with which the embodiments of the invention may be practised. Typically, the processes of the embodiments are resident as software or a computer readable program code recorded on a hard disk drive as the computer readable medium, and read and controlled using the control module 1066. Intermediate storage of the program code and any data including entities, tickets, and the like may be accomplished using the memory 1370, possibly in concert with the storage device 1062.

In some instances, the program may be supplied to the user encoded on a CD-ROM or a floppy disk (both generally depicted by the storage device 1362), or alternatively could be read by the user from the network via a modem device connected to the computer 1350. Still further, the computer system 1300 can load the software from other computer readable media. This may include magnetic tape, a ROM or integrated circuit, a magneto-optical disk, a radio or infra-red transmission channel between the computer and another device, a computer readable card such as a PCMCIA card, and the Internet 1320 and Intranets including email transmissions and information recorded on Internet sites and the like. The foregoing are merely examples of relevant computer readable media. Other computer readable media may be practised without departing from the scope and spirit of the invention.

Further to the above, the described methods can be realised in a centralised fashion in one computer system 1300, or in a distributed fashion where different elements are spread across several interconnected computer systems.

Computer program means or computer program in the present context mean any expression, in any language, code or notation, of a set of instructions intended to cause a system having an information processing capability to perform a particular function either directly or after either or both of the following: a) conversion to another language, code or notation or b) reproduction in a different material form.

In the foregoing manner, a method, an apparatus, and a computer program product for are disclosed. While only a small number of embodiments are described, it will be apparent to those skilled in the art in view of this disclosure that numerous changes and/or modifications can be made without departing from the scope and spirit of the invention.

It is understood that the invention is not limited to the embodiment described, but that various alterations and modifications, as would be apparent to one skilled in the art, are included within the scope of the invention.

We claim:

1. A method of conducting a promotional offer, the method comprising steps of:
defining the structure of a promotional offer having a plurality of associated parameters, one or more of which are unspecified or can be varied;
targeting one or more of a plurality of customers as recipients of the offer; and
distributing a record of the offer to the customers;
wherein one or more of the unspecified or variable parameters associated with the offer are individually assigned for one or more of the targeted customers to whom the record of the offer is distributed.

2. The method of claim 1, wherein the unspecified or variable parameters are defined:
(a) when the offer is presented to respective customers; or
(b) when the offer is accepted by respective customers; or
(c) when the offer is redeemed by respective customers; or
(d) when requested by respective customers.

3. The method of claim 1, wherein one or more of the unspecified or variable offer parameters are assigned default values.

4. The method of claim 3, wherein the assigned default values can be changed a predetermined number of times.

5. The method of claim 1, wherein the unspecified or variable parameters vary with time.

6. The method of claim 1, wherein the unspecified or variable offer parameters can include one or more of: offer discount information, offer validity period, and offer life period.

7. The method of claim 1, wherein one or more of the unspecified or variable offer parameters are assigned for customers on the basis of respective customer profile information.

8. The method of claim 7, wherein a plurality of the unspecified or variable offer parameters are assigned by different entities able to access different respective customer profile information.

9. The method of claim 8, wherein there is provided an incentive for the different entities to appropriately assign the unspecified or variable offer parameters.

10. The method of claim 8, wherein one or more of the unspecified or variable offer parameters are assigned within a predetermined range of values.

11. The method of claim 8, wherein one or more of the unspecified or variable offer parameters are assigned in accordance with predetermined rules.

12. The method of claim 11, wherein the predetermined rules vary for different respective customers.

13. The method of claim 11, wherein the predetermined rules specify how to determine a respective customer's eligibility to redeem the offer.

14. The method of claim 11, wherein the predetermined rules specify how to determine a respective customer's authorization to determine said one or more unspecified or variable parameters.

15. The method of claim 7, wherein the customer profile information can include demographic or behavioural information.

16. The method of claim 1, wherein respective customers can decline to redeem the offer.

17. The method of claim 1, wherein the record of the offer is an electronic coupon.

18. The method of claim 17, wherein the record of the promotional offer is distributed online.

19. The method of claim 6, wherein the unspecified or variable parameter of offer discount information is determined for each customer such that the customer's utility for the promoted product of the product identifier information exceeds that of the customer's corresponding preferred brand product.

20. The method of claim 6, wherein the unspecified or variable parameter of offer discount information is determined for each customer as the difference in price between the promoted product of the product identifier information and the customer's corresponding preferred brand product.

21. The method of claim 6, wherein the unspecified or variable parameter of offer validity period is determined for each customer as at least the period to the estimated time of the customer's next purchase.

22. A method of conducting a promotional offer, the method comprising:
defining the structure of a promotional offer to be made to a plurality of customers, the offer having a plurality of associated parameters, one or more of which are unspecified or can be varied;
wherein the unspecified or variable parameters are able to be individually assigned for one or more customers to whom a record of the offer is to be distributed.

23. A method of conducting a promotional offer, the method comprising:
distributing to one or more targeted customers a record of a promotional offer having a plurality of associated parameters; and
defining the values of one or more of the associated parameters for respective targeted customers, when requested by the respective customers;
wherein one or more of the parameters associated with the promotional offer are individually assigned to one or more of the targeted customers.

24. A method of conducting a promotional offer, the method comprising:
targeting one or more of a plurality of customers as recipients of a promotional offer having a plurality of associated parameters, one or more of which are unspecified or can be varied;
wherein one or more of the unspecified or variable parameters associated with the offer are individually assigned for one or more targeted customers to whom a record of the offer is to be distributed.

25. A method of conducting a promotional offer, the method comprising:
distributing to one or more targeted customers a record of a promotional offer having a plurality of associated parameters;
wherein one or more of the parameters associated with the promotional offer have been individually assigned to one or more of the targeted customers.

26. A computer program product having a computer readable medium having a computer program recorded therein for deciding how to classify a sample in one of a number of predetermined classes, said computer program comprising:
code means for defining the structure of a promotional offer having a plurality of associated parameters, one or more of which are unspecified or can be varied;
code means for targeting one or more of a plurality of customers as recipients of the offer; and
code means for distributing a record of the offer to the customers;
wherein one or more of the unspecified or variable parameters associated with the offer are individually assigned for one or more of the targeted customers to whom the record of the offer is distributed.

27. Apparatus for conducting a promotional offer, the apparatus comprising:
means for defining the structure of a promotional offer having a plurality of associated parameters, one or more of which are unspecified or can be varied;
means for targeting one or more of a plurality of customers as recipients of the offer; and
means for distributing a record of the offer to the customers;
wherein one or more of the unspecified or variable parameters associated with the offer are individually assigned for one or more of the targeted customers to whom the record of the offer is distributed.

28. The apparatus of claim 27, wherein the unspecified or variable parameters are defined:
(a) when the offer is presented to respective customers; or
(b) when the offer is accepted by respective customers; or
(c) when the offer is redeemed by respective customers; or
(d) when requested by respective customers.

29. The apparatus of claim 27, wherein one or more of the unspecified or variable offer parameters are assigned default values.

30. The apparatus of claim 29, wherein the assigned default values can be changed a predetermined number of times.

31. The apparatus of claim 27, wherein the unspecified or variable parameters vary with time.

32. The apparatus of claim 27, wherein the unspecified or variable offer parameters can include one or more of: offer discount information, after validity period and offer life period.

33. The apparatus of claim 27, wherein one or more of the unspecified or variable offer parameters are assigned for customers on the basis of respective customer profile information.

34. The apparatus of claim 33, wherein a plurality of the unspecified or variable offer parameters are assigned by different entities able to access different respective customer profile information.

35. The method of claim 34, wherein there is provided an incentive for the different entities to appropriately assign the unspecified or variable offer parameters.

36. The apparatus of claim 34, wherein one or more of the unspecified or variable offer parameters are assigned within a predetermined range of values.

37. The apparatus of claim 36, wherein one or more of the unspecified or variable offer parameters are assigned in accordance with predetermined rules.

38. The apparatus of claim 37, wherein the predetermined rules vary for different respective customers.

39. The apparatus of claim 37, wherein the predetermined rules specify how to determine a respective customer's eligibility to redeem the offer.

40. The apparatus of claim 37, wherein the predetermined rules specify how to determine a respective customer's authorization to determine said one or more unspecified or variable parameters.

41. The apparatus of claim 33, wherein the customer profile information can include demographic or behavioural information.

42. The apparatus of claim 26, wherein respective customers can decline to redeem the offer.

43. The apparatus of claim 26, wherein the record of the offer is an electronic coupon.

44. The apparatus of claim 43, wherein the record of the promotional offer is distributed online.

45. The apparatus of claim 32, wherein the unspecified or variable parameter of offer discount information is determined for each customer such that the customer's utility for the promoted product of the product identifier information exceeds that of the customer's corresponding preferred brand product.

46. The apparatus of claim 32, wherein the unspecified or variable parameter of offer discount information is determined for each customer as the difference in price between the promoted product of the product identifier information and the customer's corresponding preferred brand product.

47. The apparatus of claim 32, wherein the unspecified or variable parameter of offer validity period is determined for each customer as at least the period to the estimated time of the customer's next purchase.
